(19) United States
(12) Patent Application Publication
(10) Pub. No.: US 2013/0085690 A1
(43) Pub. Date: Apr. 4, 2013

(54) DATA PROCESSING METHOD AND SYSTEM FOR CHECKING PIPELINE LEAKAGE

(71) Applicants: Ben Fei, Beijing (CN); Chunhua Tian, Beijing (CN); Dong Wang, Beijing (CN); Hao Wang, Beijing (CN); Xian Wu, Beijing (CN); Jing Xiao, Beijing (CN)

(72) Inventors: Ben Fei, Beijing (CN); Chunhua Tian, Beijing (CN); Dong Wang, Beijing (CN); Hao Wang, Beijing (CN); Xian Wu, Beijing (CN); Jing Xiao, Beijing (CN)

(73) Assignee: International Business Machines Corporation, Armonk, NY (US)

(21) Appl. No.: 13/643,665

(22) PCT Filed: Apr. 21, 2011
(86) PCT No.: PCT/EP11/56399

§ 371 Date: Dec. 7, 2012

(30) Foreign Application Priority Data
Apr. 29, 2010 (CN) 201010163310.7

(51) Int. Cl. G06F 17/18

(52) U.S. Cl. CPC G06F 17/18
USPC 702/51

(57) ABSTRACT

A method for checking pipeline leakage comprises: receiving detecting parameters collected by at least one sensor with respect to pipelines in its corresponding region; gathering detecting parameters collected by the at least one sensor; analyzing the gathered detecting parameters to obtain an evolutionary tendency of detecting parameters in the corresponding region of the at least one sensor; judging if the evolutionary tendency of the detecting parameters satisfies predefined features of leakage; determining that pipeline leakage exists in the corresponding region if the evolutionary tendency of the detecting parameters satisfies the predefined features of leakage. The present invention may help to determine leak regions with a leakage having small flow quantity, and provide a user with regions with pipeline leakage to be detected based on a resource constraint.

### TECHNICAL FIELD

The present invention generally relates to the field of information processing technology, and in particular, to a data processing method and system for checking pipeline leakage.

### BACKGROUND

With the constant development of urbanization around the world, infrastructures of pipeline networks in every city are huge and are expanded continuously, in which the pipeline networks for water supply and gas supply, etc are included. Taking Beijing as example, it is reported that until the end of 2006, there have been 19 water plants in the urban areas of Beijing with water supply of 3000000 m³/day, and the total length of water supply pipelines is 8000 km. However, due to a great number of pipeline leakages, quantity of media such as water, gas, oil, etc are leaked in the world, which not only leads to waste but also potentially causes environmental pollution. Take Norway, Trondheim as example, it is reported that there are up to 250-300 explosions of water pipelines annually on average. Statistics show that 15-30% drinking water is wasted due to pipeline leakage. It is estimated by IWA (International Water Association) that 864 m³ of water was lost due to pipeline explosions reported in an earlier stage, while 7200 m³ of water was lost due to pipeline explosions which are not promptly reported. It can be seen thus prompt discovery and prompt maintenance may lower social economic losses; and reducing the leakage of water, gas, etc., is of significant to city ecological construction. It is alleged that a water company in a city of China may prevent a leakage of 30 million tons water annually by some detection/maintenance facilities.

Currently, leakage check mainly comprises the following types of methods:

Environment Investigation Method: a most intuitive method for deciding the track and range of water leakage. Based on the diagram of water supply network and information provided by related personnel, the water supply pipelines are investigated in detail. It comprise: connection, distribution, material and surrounding media of pipelines. Leakage point is decided through observing the road surface, first melting of winter snow, luxuriant above the pipelines, clear water running regularly over an underground well, etc.

Pressure Test and Comparison Method: water leakage due to pipeline damages, such as large quantity of water leakage, usually causes a reduction of partial pressure in the pipeline network, where the closer to the leakage, the lower the pressure is. By using a hydrant for pressure test and comparison, water leakage region can be found as soon as possible.

Residual Chlorine Detection Method: according to the national output water standard, the content of residual chlorine should not be less than 0.3 mg/L after chlorine has been in contact with water for 30 minutes. The content of free residual chlorine at the end of the network should not be less than 0.05 mg/L. It can be judged if there exists a leak happening in the water supply network by using the principle that residual chlorine reacts with ortho-Tolidine to generate yellow quinone compounds, and detecting the collected water sample, through visual colorimetry.

Acoustic and Listen Leakage Detection Method: it comprises three types of valve bolt audiometry for searching for the track and range of water leakage, which is called pre-location of leakage point for short; road surface audiometry and drilling location for determining location of the water leakage point, which are called accurate location of leakage point for short.

Related Leakage Detection Method: it is an advanced and effective method of leakage detection, it particularly applies to a region disturbed by loud noises or pipelines that are buried too deep or a region that is unsuitable for road surface audiometry method. A correlator is used for rapidly and accurately detecting a precise location of a water leakage of underground pipelines. The working principle hereof is: where there exists a water leakage of pipelines, water leakage sound waves are generated at the ventage and transmitted far away along the pipelines; when a sensor is placed at different locations of a pipeline or connector, the correlator mainframe may measure time difference Td of the water leak sound waves generated at the ventage transmitted to different sensors. As long as an actual length L of the pipeline between two sensors and the transmission speed V in said pipeline are given, the location Lx of the water leakage point can be calculated by the following formula Lx=(L−V×Td)/2, wherein V is dependent on material, diameter of the pipelines as well as medium inside the pipelines.

Automatic Regional Leakage Noise Detection Method: it uses a regional leakage investigation system for a centralized detection of water supply network within a district or region. First, a detector probe is set for detection and placed at a distance on subsidiary facilities of the network; the probe configured tests and automatically records noises of the pipelines within the probe according to preset requests. The probe can be withdrawn after the test in accordance with the preset time and requests; and it downloads data from a host or computer, and then instantly saves the successfully downloaded data for a further analysis. It is possible to accomplish a test of water leakage in a regional network at a time by the method, which not only reduces work strength of operation workers, but also enhances detection efficiency apparently and shortens the cycle of water leakage detection.

At present, leakage overhaul mainly comprises the following steps:

1. analyzing and investigating regional flow quantity and pipeline network pressure;
2. invoking basic data of the pipeline network (for example, drawings, etc.)
3. getting familiar with specific situation of the network;
4. conducting an environmental field investigation and a valve bolt audiometry investigation
5. road surface audimetry investigation;
6. related analysis and investigation;
7. drilling location investigation;
8. leakage confirmation;
9. re-inspection of water leakage after restoration as well as data archiving.

Detecting devices commonly used include: sound listening means, leakage detector, correlator, pipeline locator, regional leak investigating system, etc. However, the present overhaul methods have many drawbacks. For example, sensitivity is not enough locally; pressure (flow quantity, content of residual chlorine, etc) sensor fails to detect variation of detecting parameters such as pressure and so on in a very short period. In addition, even with a high accuracy leakage detector, when the leakage quantity of each dispersed point is small, resources are insufficient for a pressurized test on each point. Such case can be occasionally found in a routine detection, but the routine detection isn't enough. Besides, because of historical reasons, the number of the arranged pipeline sensors (for example, flowmeter, manometer, etc) is not enough, thus, accurate data of the leakage cannot sometimes be obtained.

### SUMMARY

In an aspect, the present invention provides a data processing method for detecting pipeline leakage, the method comprising: receiving detecting parameters collected by at least one sensor with respect to pipelines in its corresponding region; gathering detecting parameters collected by the at least one sensor; analyzing the gathered detecting parameters to obtain an evolutionary tendency of detecting parameters in the corresponding region of the at least one sensor; judging if the evolutionary tendency of the detecting parameters satisfies predefined features of leakage; determining that pipeline leakage exists in the corresponding region if the evolutionary tendency of the detecting parameters satisfies the predefined features of leakage.

In another aspect, the present invention provides a data processing system for detecting pipeline leakage, the system comprising: receiving means configured to receive detecting parameters collected by at least one sensor with respect to pipelines in its corresponding region; gathering means configured to gather detecting parameters collected by the at least one sensor; analyzing means configured to analyze the gathered detecting parameters to obtain an evolutionary tendency of detecting parameters in the corresponding region of the at least one sensor; judging means configured to judge if the evolutionary tendency of the detecting parameters satisfies predefined features of leakage; and determining means configured to determining that pipeline leakage exists in the corresponding region if the evolutionary tendency of the detecting parameters satisfies the predefined features of leakage.

The present invention overcomes such a defect in the prior art that is unable to determine region in which pipeline leakage quantity is not large enough. The present invention is able to determine such a leakage region in which leakage of flow quantity is small, and is able to help municipal departments to automatically calculate a good detection scheme based on present resources (human power, device, time) and possible leakage regions and the size of flow quantity area, namely, a scheme of accurately locating the maximum quantity of leakage under existing resources conditions, to provide the decision-making and planning departments with powerful decision supports.

### BRIEF DESCRIPTION OF THE DRAWINGS

Embodiment(s) of the invention will now be described, by way of example only, with reference to the accompanying drawings in which:

FIG. 1 shows a first embodiment of the present invention for determining pipeline leakage;

FIGS. 2 and 3 show a second embodiment of the present invention for determining pipeline leakage;

FIG. 4 shows an embodiment of the present invention for locating leakage regions to be detected by using a resource constraint;

FIGS. 5 and 6 show a third embodiment of the present invention for determining pipeline leakage;

FIG. 7 shows a block diagram of a data processing system of the present invention for determining pipeline leakage.

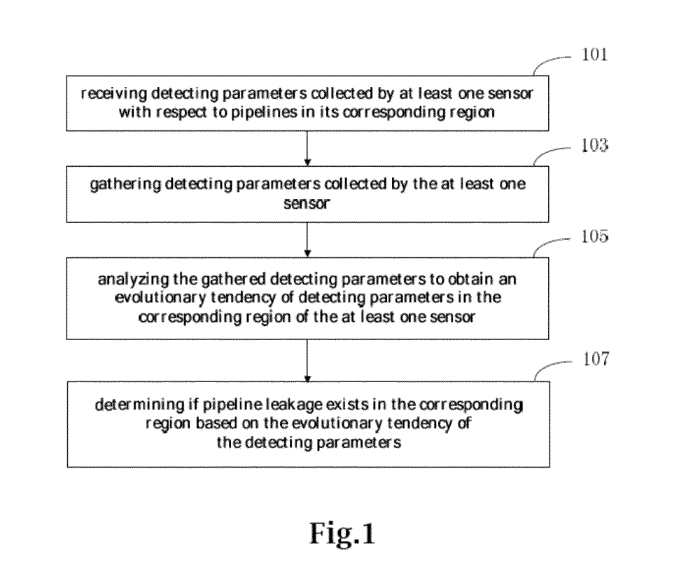

### DETAILED DESCRIPTION

Now a specific description will be made with reference to the exemplary embodiments of the present invention, and examples of the embodiments will be exemplified in the figures, in which an identical reference number always indicates the same element. It should be understood that the present invention is not limited to the disclosed exemplified embodiments. It should also be understood that not every feature of the method and device is necessary for implementing the present invention as claimed by every claim. Furthermore, in the whole disclosure, when a process or method is shown or described, method steps may be executed in any order or simultaneously, unless it is clearly shown in the context that one step is in dependence on the execution of another step. In addition, there may have an obvious interval among steps.

In current city pipelines, a certain number of sensors are arranged according to regions for detecting pipelines. Currently, water supply pipelines are mainly provided with manometer, flow meter, sludge concentration sensor, suspended solids and turbidity sensor, conductivity sensor, PH value sensor, dissolved oxygen sensor, etc. At present, means with multi-parameter for water-quality detection are sold in the market, which can meet the need of detecting multiple types of technical parameters. Pipeline leakage can be judged by observing one or more types of data. Nowadays, data that can be collected and utilized by sensors mainly comprises the following types: fluid pressure, fluid flow quantity, fluid flow rate, quantity of residual chlorine, dissolved oxygen, pH value, ORP (oxidation-reduction potential), conductivity, temperature, total dissolved gas, turbidity, etc. It is able to purchase in the market a sensor integrating with and sampling a plurality of indicators, as well as a sensor sampling a single indicator. Data structure of detecting parameters collected by a recording sensor is shown in Table 1. Of course, those skilled in the art may conceive of other appropriate data structure for recording related detecting data. Taking the pressure detection leakage data as example, the following Table 1 may be obtained by recording related pressure parameters of period within the range of sensitivity recorded by a single sensor, which, of course, is easy to be extended to the above other data indicators. Furthermore, Table 2 records corresponding regions, coverage area as well as the detected parameter types of respective sensors. Of course, it is also to simply use sensor ID to represent corresponding region of a sensor, etc. When it is actually exhibited in a way that can be understood by a user, specific regional mapping is performed, for example, a certain sensor ID represents a certain street and region, etc., therefore, in some detailed embodiments, Table 2 isn't necessary information, whereas some preferred embodiments may utilize such information. Indeed, Table 1 and Table 2 may further record information needed or specified by other users.

TABLE 1
Example of Sample Data of a Sensor

| Sensor Sample | Type of | Time of | Collected Value | |
|---|---|---|---|---|
| ID | Indicator | Collection | (Unit: Mpa) | . . . |
| Sample 1 | Pressure | 2009.01.01 00:00 | 0.28 | . . . |
| Sample 2 | Pressure | 2009.01.01 00:25 | 0.28 | . . . |
| Sample 3 | Pressure | 2009.01.01 00:50 | 0.20 | . . . |
| . . . | . . . | . . . | . . . | . . . |

TABLE 2
Related information of a Sensor

| | Corresponding | Coverage | Type of | |
|---|---|---|---|---|
| Sensor ID | Region | area | Parameter | . . . |
| 1 | Pos1 | Area1 | Pressure | . . . |
| 2 | Pos2 | Area2 | Pressure | . . . |
| 3 | Pos3 | Area3 | Content of | . . . |
| | | | Residual | |
| | | | Chlorine | |
| . . . | | . . . | . . . | . . . |

Wherein, the corresponding region in Table 2 characterizes regional location of the sensor (such as xxx Street, xxx District, etc), and the coverage area characterizes the size of area related to the detecting parameter tested by the sensor.

As stated in the Background Art, due to limit of costs and original arrangement of the network sensors, the present detection technology is unable to detect such leakage in pipelines which quantity isn't large. A first embodiment of the present invention based on detecting parameters collected by the above sensor for detecting pipeline leakage is elaborated below. In step 101, detecting parameters collected by at least one sensor with respect to pipelines in its corresponding region are received. As stated as above, a single type of detecting parameters, for instance liquid pressure parameter, as well as plurality types of detecting parameters can be received. These detecting parameters can be processed in parallel based on different indicators respectively or results obtained therefrom can also be used to check up between each other to ensure the accuracy. The detecting parameters comprise values of multiple samples collected of at least one of: fluid pressure, fluid flow quantity, fluid flow rate, content of residual chlorine, dissolved oxygen, pH value, ORP (oxidation-reduction potential), conductivity, temperature, total dissolved gas, turbidity in different time intervals. Optionally, it is possible to record specific information of regional location (such as xxx Street, xxx District) and the coverage area of a sensor to facilitate subsequent further preferred processes. In Step 103, detecting parameters collected by at least one sensor are gathered. In which, the detecting parameters may be gathered by accumulating the detecting parameters of the at least one sensor. Preferably, it is also possible to weight and collect the detecting parameters by combining geographical locations of a sensor (such as division of administrative regions) with the coverage area. For example, a method of simple K-means clustering may be used for detection data of sensors corresponding to a plurality of pipeline regions, wherein each sensor is regarded as a point, and they are clustered according to the physical distance among them. There are many documents that introduce related technologies, which may refer to http://en.wikipedia.org/wiki/K-means_clustering. Those skilled in the art may further conceive of other applicable gathering method based on the present application. In Step 105, the gathered detecting parameters are analyzed to obtain an evolutionary tendency of detecting parameters in corresponding region of the at least one sensor. In order to obtain the evolutionary tendency of the detecting parameters in the region, it is possible to perform various analyses of the gathered detecting parameters such as general numerical analysis, for example, the simplest calculation of differences of sample values of the following two periods (simply, solution of differences). Preferably, the evolutionary tendency of the detecting parameters may be obtained by means of frequency spectrum analysis of the detecting parameters. The method of frequency spectrum analysis may use Fourier transform, Wavelet Transform or orthogonal basis of Euclidean Space per se for transformation, etc. It is possible to get to know the feature of variation of leakage with time based on the evolutionary tendency of the detecting parameters. In Step 107, it is determined if pipeline leakage exists in the corresponding region based on the evolutionary tendency of the detecting parameters. By summarizing rich experiences in this field and combining with a mass of related experiments done by himself, the applicant discovered that a local leakage mainly comprises the following features:

1) Continuous increase of flow quantity occurs abruptly;
2) The flow quantity is stable within any period (or grows steadily like step);
3) The flow quantity does not decrease within any period;
4) Even in a case of extreme low usage quantity (for example, at middle night), the flow quantity is still close to or similar to that of the peak period (the same pressure); if the quantity of variation is very small and it can be detected only by using specialized instruments, whereas the variation is regular (time related) which is different from rules for industrial water and civil water.

With technology and increase of practices that small quantity of leakages are processed, more effective features of leakage for determining a leakage can be concluded. Thus, the present application is in accordance with the feature of leakage including but not limited to at least one of the above features, whereas the above features are only used for description the implementation of the present invention, and should not be construed as limiting the protection scope of the present invention. It is determined if leakage exists in pipelines of the corresponding region based on the evolutionary tendency of the detecting parameters. Preferably, it is possible to judge if the evolutionary tendency of the detecting parameters satisfies the predefined features of leakage. Said predefined features of leakage can be at least one of the above features, or can be constantly updated with the development of technologies in the art. It can be determined that leakage exists in pipelines of the corresponding region, if the evolutionary tendency of the detecting parameters satisfies the predefined features of leakage.

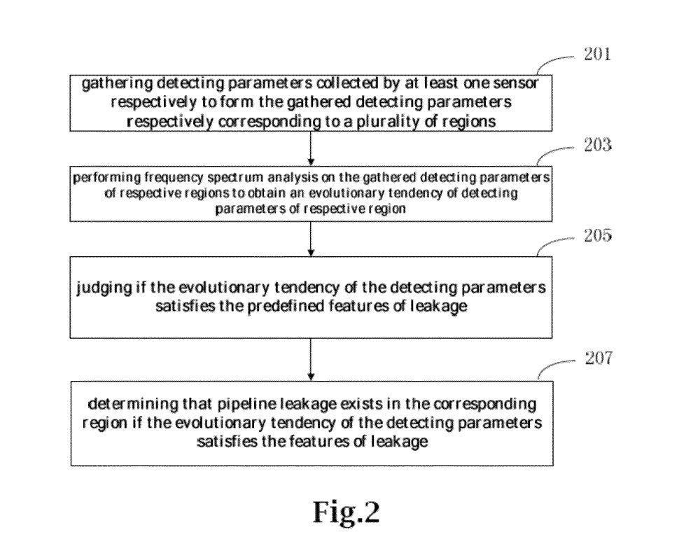

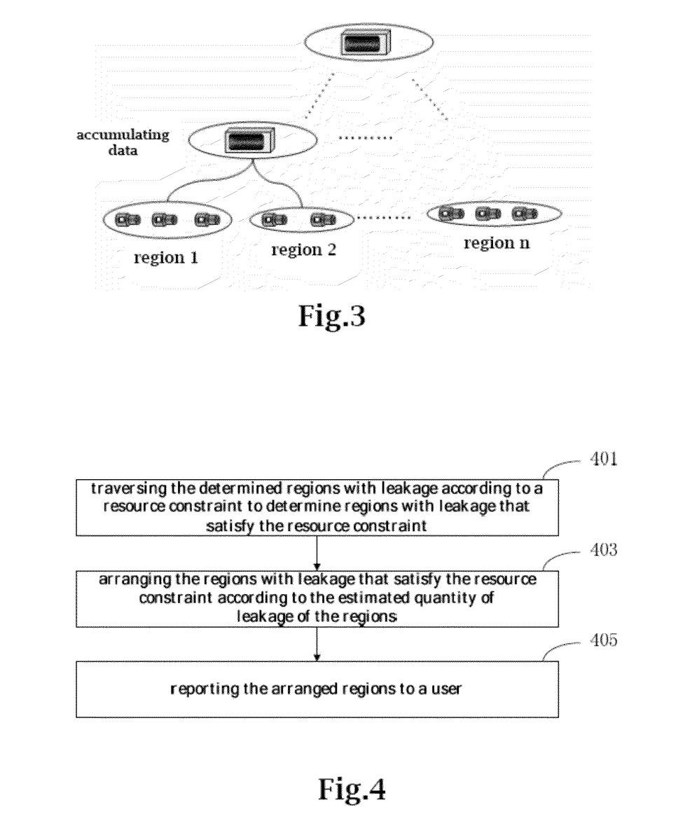

FIGS. 2 and 3 show a second embodiment for determining pipeline leakage. Wherein, in Step 201, detecting parameters collected by at least one sensor are respectively gathered to form the gathered detecting parameters corresponding to a plurality of regions respectively. The method of gathering may be performed upwardly: as to each sensor node, detecting parameters of x geographically adjacent sensors are gathered (the above variety of methods of gathering may be adopted, preferably, a simply accumulation may be used, such as accumulation of flow quantity, accumulation of pressure, in dependence on the type of sensor), to form an intermediate node, these are circulated until all of them are gathered as one node, namely, a root node. The value of x can be arbitrarily set based on needs of a user (for example, the location and coverage area during the arrangement of the sensor, etc.) with a minimum value of 1, while the maximum value may be the number of all sensors; and the value of x can be adjusted according to related locations of sensors, for example, x can be properly increased if the number of sensors nearby are more. Data of sensors can as well be gathered to form, for instance, regional detecting data of a living area of a district of a city, by combining the division of city administrative regions with detecting parameters and location information of sensors. Regions that correspond to the gathered detecting data are just the sum of regions that correspond to the originally dispersed detecting data (or, the sum of the coverage areas). The gathering process and the result obtained in Step 201 may be shown in FIG. 3, in which thus formed leaf nodes are the detecting parameters corresponding to regions 1-n formed by the gathered detecting parameters of x sensors, whereas the intermediate nodes and the final root node construct a tree structure of regional detecting parameters of an upper layer formed by further gathering of detecting parameters of the leaf nodes, so as to facilitate a subsequent preferred process. It is noted that the number of sensors in FIG. 3 is only for illustration, and shall not be construed as definition of the protection scope of the present application. In step 203, a frequency spectrum analysis is performed on the gathered detecting parameters of respective regions to obtain evolutionary tendencies of detecting parameters of respective regions. In the node tree shown in FIG. 3, as to nodes of each layer, the accumulated values are combined with time to calculate the corresponding spectral values. A variety of candidate means may be adopted for the frequency spectrum analysis: Fourier transform, Wavelet Transform, both of which belong to orthogonal basis transformation of function space; or orthogonal basis of Euclidean Space per se for transformation is used to select a set of appropriate orthogonal bases, simply, natural basis, namely, a set of bases that constitute an identity matrix, and then the transformed values are equal to the initial ones. Through any one of the above methods of frequency spectrum transformation, if the original data collected by a sensor relates to time t, the value of which is f(t), then after transformation, the value is F(T). If natural basis is used, then f=F. A first order differential d₁ and a second order differential d₂ in a given period ([T₁, T₂]) are computed by using the spectral value F(T) obtained through calculation. Differential formulae with a standard definition are as follows:

d₁(T)=(F(₂)−F(T₁))/(T₂−T₁) (1)

d₂(T)=(d₁(T₂)−d1(T₁))/(T₂−T₁) (2)

If it is a transformation using natural basis, taking the gathered detecting parameters being fluid pressure as example, then the first order differential d₁ is the simplest difference of fluid pressure, and the second order differential d₂ is a difference of change speed of fluid pressure. The first order differential d₁ and the second order differential d₂ of the above respective regions represent or determine evolutionary tendencies of detecting parameters of respective regions.

In Step 205, it is judged if the evolutionary tendency of the detecting parameters satisfies the predefined features of leakage. Specifically, corresponding to the above summarized features of a local leakage, the evolutionary tendency of the detecting parameters can be determined by judging features of the first order increment and second order increment according to at least one of the following:

1′) the first order increment of frequency spectrum of detecting parameters within any period is uniform;
2′) the second order increment of frequency spectrum of detecting parameters within any period is uniform;
3′) the first order increment of frequency spectrum of detecting parameters within any period is a non-decreasing function; and
4′) the second order increment of frequency spectrum of detecting parameters in peak period is consistent with that in ordinary period.

In Step 207, it is determined that pipeline leakage exists in the corresponding region if the evolutionary tendency of the detecting parameters satisfies the predefined features of leakage. Specifically, if at least one or more of the above four features 1′), 2′), 3′), 4′) are met, it is judged that the leakage exists in the node. As to estimation of quantity of leakage, taking the fluid pressure collected by a sensor as example, the quantity of leakage is estimated based on the pressure value (or indicators of other samples), generally speaking, the greater the pressure difference is, the larger the quantity of leakage will be. Similar deduction also applies to other indicators. A relevant region is marked as leakage if it is determined that leakage exists in it. The relevant region is marked as not leakage if it is determined that no leakage exists in it. However, it may not be marked yet and it is agreed that none of marks represents no leakage, which is as well a way of marking Taking the node tree of the leak region shown in FIG. 3 as example, the regional node tree marking the leakage or not can be obtained. The result may be presented to a user, or serve as a database for the user's query and so on. In addition, preferably, it is possible to mark the coverage area corresponding to the leak region, by accumulating leak areas corresponding to respective sensors in the leak region.

Further, a user may be unable to detect all the regions marked with leakage due to objective causes, and FIG. 4 shows a specific embodiment of the present invention for locating leak regions to be detected by using a resource constraint. Wherein, if the area that can be detected under the condition of unit time, unit device, unit human power is represented by s, and the total detected area obtained by a user's input of available time, device and human power according to his own situation is represented by S, then the resource constraint for detection is formed. In Step 401, the determined regions with leakage are traversed according to a resource constraint to determine regions with leakage that satisfy the resource constraint. Specifically, it is possible to set an empty queue V for placing nodes to be surveyed manually, an area covered by all the nodes in the queue is set as S(V), child nodes shown in FIG. 3 are traversed from the root node of the node tree:

a) check if child node is marked as leakage, if so, check the scope covered by the child node; if it is smaller than S−S(V), add the node to queue V and stop searching for a child node of said node; and start from a next child node of the same parent node again;
b) if the scope covered by the node is greater than S−S(V), then it can't be added to the queue, and continually search for a child node of the node, and return to Step a);
c) if S−S(V)=0, or tends to 0, then stop searching.

In Step 403, the regions with leakage that satisfy the resource constraint are arranged according to the estimated quantity of leakage of the regions. Specifically, all the nodes in V are arranged according to the gathered detecting parameters characterizing the quantities of leakage, either in ascending order or descending order. If possible quantities of leakage in two groups of sensors are equal, then they are arranged according to the larger one of sizes of regional area covered by them, preferentially selecting the one with a larger area. In Step 405, the arranged regions are reported to the user. In this way, it is possible to ensure to preferentially detect regions with a larger quantity of leakage under the condition within detecting resources of a user so as to prevent enormous waste due to overlong time waiting for detection and reparation.

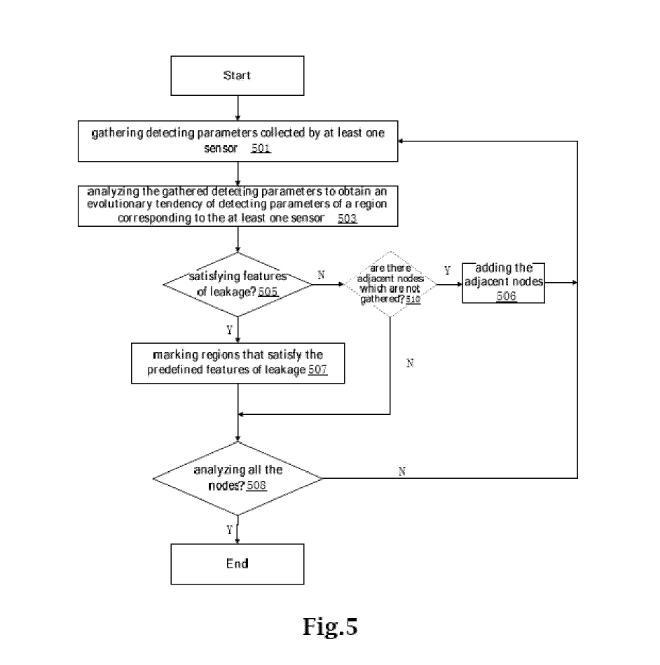

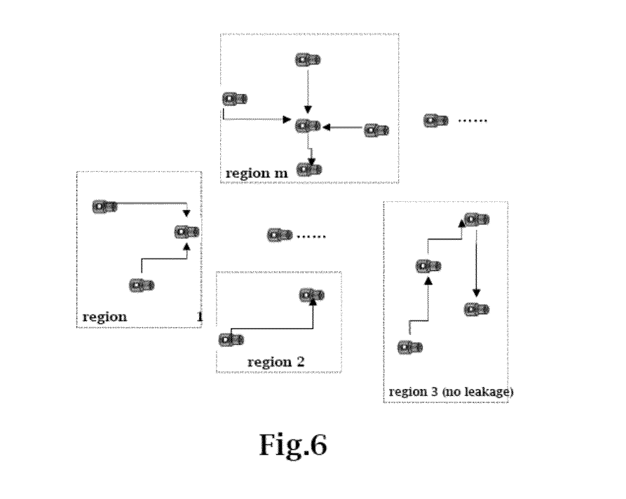

FIGS. 5 and 6 show a third embodiment of the present invention for determining pipeline leakage. Wherein, in Step 501, detecting parameters collected by at least one sensor are gathered. Specifically, as shown in FIG. 6, detecting parameters collected by a plurality of sensor form a plurality of nodes. Geographically adjacent nodes are gathered starting from a node of detecting parameters of any sensor. The method of gathering is aforementioned. It is possible to gather detecting parameters of one sensor or x sensors at a time. In Step 503, the gathered detecting parameters are analyzed to obtain an evolutionary tendency of detecting parameters of a region corresponding to the at least one sensor. The specific method of analyzing may be stated as above, so as to obtain an evolutionary tendency of detecting parameters. In Step 505, it is judged if the evolutionary tendency of detecting parameters satisfies the predefined features of leakage. If so, then the region is marked as a leakage region in Step 507; if no, in Step 506, based on the node of the gathered detecting parameters, it is possible to additionally gather at least one adjacent node of the detecting parameters (preferably, Step 510 may be added to judge if there are any remaining nodes nearby that can be gathered; if no, then turn to Step 508); the above Steps 501, 503 and 505 are repeated for finding regions with leakage; preferably, resource constraint threshold may be added at this time (which can be several percent of the above resource constraint, but it is less than or equal to the above resource constraint), for example, if the scope covered by the region is larger than or equal to the resource constraint threshold but leakage isn't detected in the region, the region may be discarded or be marked as no leakage, and the above Steps 501, 503 and 505 don't need to repeat. In Step 508, it is judged if all nodes of detecting parameters are gathered, if yes, the process ends; otherwise, the above Steps 501, 503 and 505 are repeated to traverse new nodes of the detecting parameters. After the above Steps 501, 503 and 505 are performed circularly, the divided regions with leakage shown in FIG. 6 can be obtained, where regions without leakage are discarded or marked as no leakage. FIG. 6 only exemplarily marks two regions with “leakage” or “no leakage” respectively. Preferably, the quantity of leakage as well as the total coverage area and the like can be marked according to the aforementioned method. Besides, if there are a plurality of leakage data nodes of the sensor, a graphic formed by the nodes can be divided into multiple graphic regions according to geographically adjacent locations, and the above method is executed in parallel upon the multiple graphic regions to improve efficiency. The present variety of methods may be applied to the divided graphic regions to gather sensor nodes, for example, using a simple method of K-means clustering, wherein each sensor is regarded as a node, where they are clustered according to the physical distance between them. There are many documents that introduce related technologies, which may refer to http://en.wikipedia.org/wiki/K-means_clustering. Those skilled in the art may further conceive of other applicable embodiment based on the present application.

The present invention further provides another embodiment for locating leak regions to be detected by using a resource constraint. Specifically, a threshold of the resource constraint can be added to the above Step 501 to limit gathering regions into an overlarge detecting area. Preferably, leak regions marked by the third embodiment are arranged in a descending order according to the estimated quantities of leakage to form a queue V; the node S in which coverage area of leakage regions are greater than or equal to it are filtered according to the resource constraint S inputted by the user; the areas S(V) covered by the node ahead of the queue V are accumulated, when S−S(V)=0 or tends to 0, the accumulation is stopped, and nodes after the stop node are deleted; the queue V is presented to the user to locate leak regions and perform a detection. This scheme is a special example of traversing and searching for leakage regions in the tree-shaped node tree, which is equivalent to a tree with only one layer of leaf nodes and one aggregated root node; then leakage point can be found by traversing according to the sequence of the above method. Of course, those skilled in the art can use ascending order or an arrangement scheme of the ordering of comprehensive indicators of detecting area and flow quantity.

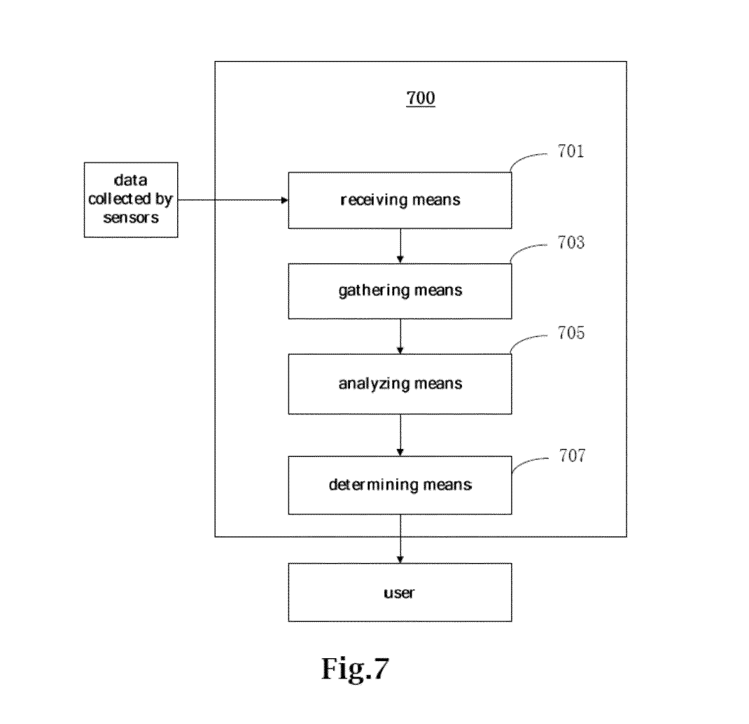

The present invention further provides a data processing system for checking pipeline leakage. FIG. 7 shows a block diagram of data processing system 700 for determining pipeline leakage. The data processing system comprises receiving means 701, gathering means 703, analyzing means 705, judging means 706 and determining means 707. Wherein, the receiving means 701 are configured to receive detecting parameters collected by at least one sensor with respect to pipelines in its corresponding region; the gathering means 703 are configured to gather detecting parameters collected by the at least one sensor; analyzing means 705 are configured to analyzing the gathered detecting parameters to obtain an evolutionary tendency of detecting parameters in the corresponding region of the at least one sensor; the judging means 706 are configured to judge if the evolutionary tendency of the detecting parameters satisfies predefined features of leakage; the determining means 707 are configured to determine that pipeline leakage exists in the corresponding region if the evolutionary tendency of the detecting parameters satisfies the predefined features of leakage. Since the methods the above respective means relate to have been illustrated, they will be omitted for brevity.

Preferably, wherein the gathering means 703 comprises: means configured to gather detecting parameters collected by at least one sensor respectively to form the gathered detecting parameters respectively corresponding to a plurality of regions.

Preferably, the system 700 further comprises: means configured to mark region with pipeline leakage in a plurality of regions based on determining that pipeline leakage exists in the corresponding region.

Preferably, the system 700 further comprises: means configured to, if determining that no pipeline leakage exists in the corresponding region, re-gather detecting parameters collected by at least one of other sensors based on the previously gathered detecting parameters, and using the means configured to judge if the evolutionary tendency of the detecting parameters satisfies predefined features of leakage and the means configured to determine that pipeline leakage exists in the corresponding region if the evolutionary tendency of the detecting parameters satisfies the predefined features of leakage until obtaining region with pipeline leakage.

Preferably, wherein, the system hereof further comprises using the gathering means 703, analyzing means 705, judging means 706 and determining means 707 circularly to determine a plurality of regions with pipeline leakage.

Preferably, wherein, the gathering detecting parameters collected by at least one sensor comprises accumulating detecting parameters of the at least one sensor.

Preferably, wherein, the analyzing the gathered detecting parameters comprises performing frequency spectrum analysis on the gathered detecting parameters.

Preferably, wherein, the analyzing means 705 further comprises: means configured to compute a first order increment and a second order increment of frequency spectrum of the gathered detecting parameters obtained through the frequency spectrum analysis; and means configured to judge features of the first order increment and second order increment to determine the evolutionary tendency of the detecting parameters.

Preferably, wherein, the means configured to judge features of the first order increment and second order increment to determine the evolutionary tendency of the detecting parameters comprises at least one of: means configured to judge if a first order increment of frequency spectrum of detecting parameters within any period is uniform; means configured to judge if a second order increment of frequency spectrum of the detecting parameters within any period is uniform; means configured to judge if the first order increment of frequency spectrum of detecting parameters within any period is a non-decreasing function; and means configured to judge if the second order increment of frequency spectrum of detecting parameters in peak period is consistent with that in ordinary period.

Preferably, it further comprises: means configured to locate leakage region requested to be detected by using a resource constraint based on the determined at least one region with pipeline leakage.

Preferably, wherein, the means configured to locate comprises: means configured to traverse the determined regions with pipeline leakage according to the resource constraint to determine regions with pipeline leakage that satisfy the resource constraint; means configured to arrange the regions with pipeline leakage that satisfy the resource constraint according to estimated quantities of leakage of the regions.

In addition, the data processing method of the present invention for detecting pipeline leakage may also be implemented by a computer program product. The computer program product comprises a software code portion for implementing a simulation method of the present invention when the computer program product is executed on a computer.

The present invention can further be implemented by recording a computer program on a computer-readable recording medium. The computer program comprises a software code portion for implementing a simulation method of the present invention when the computer program is executed on a computer. In other words, the process of the simulation method of the present invention can be distributed in the form of instructions in the computer-readable medium or in other forms, regardless of the specific type actually used for executing the distributed signal carrying medium. Examples of the computer-readable medium include: medium such as EPROM, ROM, tape, paper, floppy disk, hard disk drive, RAM, CD-ROM, as well as transmission-type medium such as digital and analog communication link.

Although the preferred embodiments of the present invention specifically exhibit and describe the present invention, those skilled in the art should understand that various amendments can be made in the forms and details thereof without deviating from the spirit and scope of the present invention defined by the claims.

1. A data processing method for checking pipeline leakage, the method comprising:
receiving detecting parameters collected by at least one sensor with respect to pipelines in its corresponding region;
gathering detecting parameters collected by the at least one sensor;
analyzing the gathered detecting parameters to obtain an evolutionary tendency of detecting parameters in the corresponding region of the at least one sensor;
judging if the evolutionary tendency of the detecting parameters satisfy predefined features of leakage; and
determining that pipeline leakage exists in the corresponding region if the evolutionary tendency of the detecting parameters satisfies the predefined features of leakage.

2. The method according to claim 1, wherein the gathering comprises gathering detecting parameters collected by at least one sensor respectively to form the gathered detecting parameters respectively corresponding to a plurality of regions.

3. The method according to claim 1, further comprising:
in response to determining that no pipeline leakage exists in the corresponding region, (i) re-gathering detecting parameters collected by at least one of other adjacent sensors based on the previously gathered detecting parameters, (ii) performing the judging if the evolutionary tendency of detecting parameters satisfies the predefined features of leakage, and (iii) determining that pipeline leakage exists in the corresponding region if the evolutionary tendency of detecting parameters satisfies the predefined features of leakage, until obtaining region with pipeline leakage.

4. The method according to claim 1, further comprising:
repeating the gathering step, analyzing step, judging step and determining step until determining a plurality of regions with pipeline leakage.

5. The method according to claim 2, further comprising:
in response to determining that leakage exists in pipelines of the corresponding region, marking region with pipeline leakage in a plurality of regions.

6. The method according to claim 2, further comprising:
in response to determining the region with pipeline leakage, locating region with pipeline leakage requested to be detected by using a resource constraint.

7. The method according to claim 6, wherein the locating region with pipeline leakage requested to be detected by using a resource constraint comprises:
traversing the determined regions with pipeline leakage according to the resource constraint; and
arranging the regions with pipeline leakage according to estimated quantities of leakage.

8. The method according to claim 1, wherein the gathering detecting parameters collected by at least one sensor comprises accumulating detecting parameters of the at least one sensor.

9. The method according to claim 1, wherein the analyzing the gathered detecting parameters comprises performing frequency spectrum analysis on the gathered detecting parameters.

10. The method according to claim 9, wherein the analyzing the gathered detecting parameters to obtain an evolutionary tendency of the detecting parameters in the at least one region further comprises:
computing at least one of a first order increment and a second order increment of frequency spectrum of the gathered detecting parameters obtained through the frequency spectrum analysis; and
judging features of at least one of the first order increment and second order increment to determine the evolutionary tendency of the detecting parameters.

11. The method according to claim 10, wherein the judging if the evolutionary tendency of the detecting parameters satisfies the predefined features of leakage comprises judging at least one of:
if a first order increment of frequency spectrum of detecting parameters within any period is uniform;
if a second order increment of frequency spectrum of the detecting parameters within any period is uniform;
if the first order increment of frequency spectrum of detecting parameters within any period is a non-decreasing function; and
if the second order increment of frequency spectrum of detecting parameters in peak period is consistent with that in ordinary period.

12. The method according to claim 1, wherein the detecting parameters comprise multiple sample values of at least one of: fluid pressure, fluid flow quantity, fluid flow rate, content of residual chlorine, dissolved oxygen, pH value, oxidation-reduction potential, conductivity, temperature, total dissolved gas, and turbidity in different time intervals.

13. A data processing system for checking pipeline leakage, the system comprising:
receiving means configured for receive detecting parameters collected by at least one sensor with respect to pipelines in its corresponding region;
gathering means configured to gather detecting parameters collected by the at least one sensor;
analyzing means configured to analyze the gathered detecting parameters to obtain an evolutionary tendency of detecting parameters in the corresponding region of the at least one sensor;
judging means configured to judge if the evolutionary tendency of the detecting parameters satisfies predefined features of leakage; and
determining means configured to determine that pipeline leakage exists in the corresponding region if the evolutionary tendency of the detecting parameters satisfies the predefined features of leakage.

14. The system according to claim 13, wherein the gathering means comprises; means configured to gathering detecting parameters collected by at least one sensor respectively to form the gathered detecting parameters respectively corresponding to a plurality of regions.

15. The system according to claim 13, further comprising:
means configured to, if determining that no pipeline leakage exists in the corresponding region, (i) re-gather detecting parameters collected by at least one of other sensors based on the previously gathered detecting parameters, (ii) using the judging means, and (iii) using the determining means until obtaining region with pipeline leakage.

16. The system according to claim 13, further comprising:
means configured to repeat the gathering means, analyzing means, judging means and determining means until determining a plurality of regions with pipeline leakage.

17. The system according to claim 14, further comprising:
means configured to mark region with pipeline leakage in a plurality of regions based on determining that pipeline leakage exists in the corresponding region.

18. The system according to claim 14, further comprising:
means configured to locate region with pipeline leakage requested to be detected by using a resource constraint based on the determined region with pipeline leakage.

19. The system according to claim 18, wherein the means configured to locate comprises:
means configured to traverse the determined regions with pipeline leakage according to the resource constraint to determine regions with pipeline leakage that satisfy the resource constraint; and
means configured to arrange the regions with pipeline leakage that satisfy the resource constraint according to estimated quantities of leakage of the regions.

20. The system according to claim 13, wherein the gathering detecting parameters collected by at least one sensor comprises accumulating detecting parameters of the at least one sensor.

21. The system according to claim 13, wherein the analyzing the gathered detecting parameters comprises performing frequency spectrum analysis on the gathered detecting parameters.

22. The system according to claim 21, wherein the analyzing means further comprises:
means configured to compute at least one of a first order increment and a second order increment of frequency spectrum of the gathered detecting parameters obtained through the frequency spectrum analysis; and
means configured to judge features of at least one of the first order increment and second order increment to determine the evolutionary tendency of the detecting parameters.

23. The system according to claim 21, wherein the judging means further comprises at least one of:
means configured to judge if a first order increment of frequency spectrum of detecting parameters within any period is uniform;
means configured to judge if a second order increment of frequency spectrum of the detecting parameters within any period is uniform;
means configured to judge if the first order increment of frequency spectrum of detecting parameters within any period is a non-decreasing function; and
means configured to judge if the second order increment of frequency spectrum of detecting parameters in peak period is consistent with that in ordinary period.
